(19) United States
(12) Patent Application Publication
(10) Pub. No.: US 2016/0127353 A1
(43) Pub. Date: May 5, 2016

(54) METHOD AND APPARATUS FOR ENABLING SECURED CERTIFICATE ENROLLMENT IN A HYBRID CLOUD PUBLIC KEY INFRASTRUCTURE

(71) Applicant: MOTOROLA SOLUTIONS, INC., SCHAUMBURG, IL (US)

(72) Inventors: SHANTHI E. THOMAS, HOFFMAN ESTATES, IL (US); ANTHONY R. METKE, NAPERVILLE, IL (US); MARK D. SEABORN, ALGONQUIN, IL (US)

(21) Appl. No.: 14/528,762

(22) Filed: Oct. 30, 2014

(51) Int. Cl. H04L 29/06

(52) U.S. Cl. CPC H04L 63/0823; H04L 63/0876

(57) ABSTRACT

In a method a public key infrastructure (PKI) device receives a certificate signing request (CSR) and an identity assertion cryptographically bound to an end entity issuing the CSR. The PKI device validates the authenticity and integrity of the CSR using the identity assertion. In response to validating the authenticity and integrity of the CSR, the PKI device issues a certificate based on at least one of the CSR and fields in the identity assertion.

### BACKGROUND OF THE INVENTION

Digital certificates created in a public key infrastructure (PKI) may be used, for example, to verify that a particular public key belongs to a certain end entity and may be used for access control. PKI services are typically complex and expensive, especially when all of the PKI components (including, but is not limited to, registration authorities (RAs), certificate authorities (CAs) and trust anchors, certificate repository, and certificate policies) are hosted in secured environments (for example, environments outside of a public network). This expense and complexity may lead some enterprise customers to defer implementation of PKI services. To reduce the cost associated with setting up PKI services, some enterprise customers may transfer some PKI functions to a “cloud” infrastructure (for example, a public cloud which is shared infrastructure on a public network such as the Internet). In these instances, the cloud infrastructure may be used during certificate enrollment. For example, an administrator may set up a corporate account and establish profiles on the cloud infrastructure, wherein the enterprise customers may use the established profiles to issue certificates. The term “cloud” as discussed herein is related to “public clouds” and the term “cloud provider” as discussed herein is related to a “public cloud provider”.

As is typical of cloud infrastructure, services or applications hosted by a cloud provider may be executed on one or more devices belonging to the cloud provider. The hosted services/application may belong to multiple customers and are typically not assigned to specific hardware. Instead, hosted services or applications belonging to multiple customers may be executed on a single device. Each service or application hosted on the cloud infrastructure may be assigned processing time on one or more of the devices belonging to the cloud provider. As such, information associated with a hosted service or application may be copied on available devices during assigned processing time, allowing the cloud provider to reduce processing cost which may be extended to enterprise customers offering PKI services. Cloud infrastructure also allows for reduced cost in extending enterprise services to a mobile environment.

However, executing PKI functions on cloud infrastructure raises security issues. Consider, for example, that services associated with a certificate authority (CA) (i.e., the PKI component that generates certificates) are executed on the cloud infrastructure. In such a case, the CA private key that is used to sign the certificate will also be hosted on the cloud infrastructure, making the CA private key vulnerable to unauthorized access from the cloud service provider and/or other cloud customers. To avoid compromising the CA private keys which would lead to total collapse of trust in the PKI, a cloud PM service of even basic or medium level of assurance would store its CA signing keys outside of the cloud infrastructure. However, if the CA's private key is hosted off-line in, for example, a tamper resistant hardware security module (HSM), when the CA is executed on the cloud infrastructure, a CA instance may be executed on any virtual machine instance, making security associations between CA instances and physical HSMs impractical.

In order to protect the CA signing keys, a PKI vendor may provide its PKI service via either a private cloud PKI (i.e., outside of the public cloud infrastructure) or via a hybrid cloud PKI. As noted previously, private cloud services are typically expensive and may not yield the benefits of moving to the cloud because of the costs associated with both the private cloud infrastructure and PKI infrastructure. In a hybrid cloud PKI, a vendor may store some PKI functions and data on public cloud infrastructure and store other data (for example, the CA signing keys) outside of the public cloud infrastructure. For instance, in a hybrid cloud PKI, the CA and/or CA signing keys may be “hosted” in a secure environment (for example, on a secured server), without direct access to cloud subscribers, and other PKI components (for example, a registration authority (RA)) may be hosted on the cloud infrastructure and may function as a front-end for PM services. For instance, the cloud-hosted RA(s) may implement data entry forms for certificate signing requests (CSRs), accept CSRs from subscribers, and perform some initial vetting functions on behalf of an issuing CA.

The term vetting refers to the checks taken by a PKI component, such as an RA or a CA, to verify the identity of the subject in the CSR, to verify whether a subject in the CSR is part of an organization claimed in the CSR, and to verify whether the subject in the CSR is entitled to receive a requested certificate for its intended usage. The vetting may involve several automated and/or manual procedures that may include, but are not limited to, verifying the presence of an end entity (i.e., a user or device) requesting a certificate in an organization's database or verifying the end-entity's identity by using other documents provided by the end entity.

Certificate enrollment as discussed herein is directed to a process associated with obtaining an initial certificate for an end entity from the CA. During certificate enrollment, the end entity sends an initial CSR to PKI component(s) to request a certificate from the PKI component(s). However, because this is the initial CSR, if the PKI had not issued any prior certificates to the end entity, the end entity typically would not have reliable means of cryptographically protecting and binding the initial CSR before sending the initial CSR across a network. To prevent unauthorized access to the initial CSR that may result in the CA issuing a legitimate certificate to a compromised CSR, the initial CSR sent from the end entity has to be protected. Issuing a certificate refers to the process of vetting and validating the CSR, generating the certificate, and sending the certificate to the requester and associated the certificate repositories. Typically in a secured environment (for example, at a manufacturer's site before a device is provided to a subscriber), the initial CSR is sent to a registration authority (RA) connected to the end entity. Or when the RA/CA is in a trusted environment, transport layer security (TLS) between the certificate client and the RA/CA may be used to protect the certificate enrollment CSR during transit.

The above issues and security concerns with certificate enrollment exists in the hybrid cloud PKI as well. However, the solutions applicable for on-premises PKI or managed PM solutions are not practical or cost-beneficial in the cloud PKI scenario. In order to have an RA in a secure environment, it implies that the RA has to be on-premises or, in other words, not on the cloud. This would again reduce the return on investment for agencies looking to benefit from a cloud-PKI. Having an RA connect to each end-entity that is enrolling for a certificate is not a scalable solution and would only add to the cost of providing PKI services.

Having the cloud-hosted RA sign the enrollment CSR would imply trusting the cloud RA keys, which as mentioned earlier, is not reliable because of the issues associated with unauthorized access to keys in the cloud by the cloud service provider and/or other cloud customers. It would therefore not suffice for the end entity to have a security association with a cloud-hosted PKI front-end and for the cloud-hosted PKI front-end in turn to have a security association with the CAs as this would require the CA to base its trust of the initial CSR on the signature of the cloud-hosted PKI entity. Thus, the end entity has no reliable means of cryptographically protecting and binding the initial CSR before sending the initial CSR across the hybrid cloud PKI network to the CA. Protecting the integrity of the initial CSR and preventing the issuance of a certificate in response to a compromised CSR is an integral part of maintaining the trust fabric of the PKI system.

Accordingly, there is a need for an apparatus and method for enabling secured certificate enrollment in a hybrid cloud PKI environment.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a hybrid cloud public key infrastructure (PKI) apparatus used in accordance with some embodiments.

FIG. 2 is a block diagram of a PKI device used in accordance with some embodiments.

FIG. 3 is a flow diagram of a method for processing a certificate signing request in a hybrid cloud PM environment in accordance with some embodiments.

FIG. 4 is a flow diagram of a method for requesting a certificate in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to apparatuses and methods for enabling certificate enrollment in a hybrid cloud PKI environment. In a method, a public key infrastructure (PKI) device receives a certificate signing request (CSR) and an identity assertion cryptographically bound to an end entity issuing the CSR. The PKI device validates the authenticity and integrity of the CSR using the identity assertion. In response to validating the authenticity and integrity of the CSR, the PKI device issues a certificate based on at least one of the CSR and fields in the identity assertion.

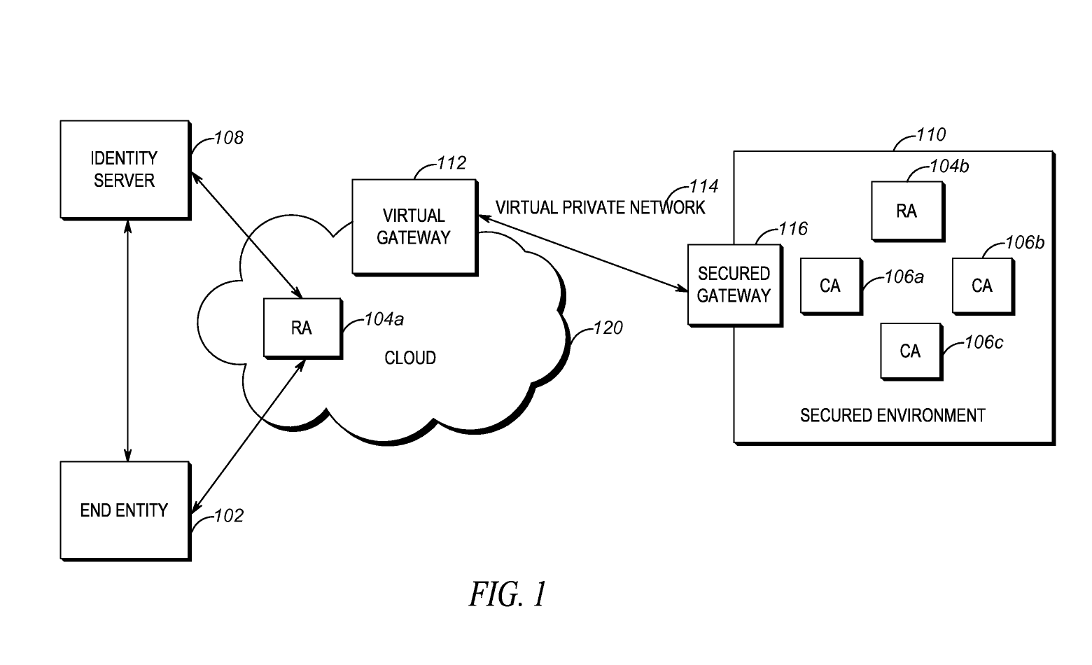

FIG. 1 is a block diagram of a hybrid cloud public key infrastructure (PKI) apparatus used in accordance with some embodiments. The hybrid cloud PM apparatus includes an end entity 102 that is configured to request a certificate from PKI components/entities/devices. End entity 102 may be any client device/computing device (for example, laptops, mobile or portable phones, smartcards, personal digital assistants or smart phones) that is configured to request the certificate from PKI components. One or more of the PKI components may be hosted on cloud infrastructure 120 (referred to herein as the “cloud” 120) and one or more PKI components may be hosted in a secured environment 110 (i.e., an environment separated from cloud infrastructure 120), thereby protecting the private keys and other information of those PKI components that are not hosted on cloud 120 from other cloud users while providing the benefits associated with cloud 120 through the PKI components hosted in cloud 120. For example, registration authority (RA) 104a may be hosted in cloud 120 and RA 104b and certificate authority (CA) 106 (i.e., CA 106a-106c) may be hosted in secured environment 110. It should be noted that PKI components hosted in secured environment 110 may be stored in separate locations. Only one secured environment 110 is shown for ease of illustration. Accordingly, in the hybrid cloud PKI apparatus, RA 104a functions as a cloud-hosted PKI front-end (also referred to herein as a cloud-hosted PKI device) and may have security associations via, for example, virtual gateway 112, virtual private network 114, and secure site gateway 116, with the PKI components hosted outside of cloud 120 (also referred to herein as non-cloud-hosted PKI devices).

The hybrid cloud PKI apparatus also includes an identity server 108 hosted in a secured environment and that is configured to issue a holder-of-key (HOK) assertion. The HOK assertion is a signed object that informs a relying party that an entity named in the HOK assertion (i.e., the entity associated with the public key presented in the HOK assertion) has a user account with an identity provider and is in possession of a HOK key pair (i.e., the entity has both the public key presented in the HOK assertion and an associated private key). The HOK key pair is locally generated on end entity 102. Thus, the HOK assertion is said to be cryptographically bound to the end entity identified in the identity assertion.

A HOK token may be obtained using standard identity protocols (for example, OAuth2.0 and SAML2.0) that allows end entity 102 to send, in a HOK token request to identity server 108, the public key of the HOK key pair that is to be included in the HOK assertion. Subsequent to receiving the HOK token request, in cases where end entity 102 has not been previously authenticated by identity server 108, identity server 108 may prompt end entity 102 for credentials assigned to end entity 102 by, for example, the identity provider. Subsequent to authenticating the credentials received from end entity 102, identity server 108 may issue the HOK assertion. The HOK assertion is signed with the private key of identity server 108 before being transmitted to the requesting end entity.

The HOK assertion includes, as one of its attributes, the public key of the HOK key pair. Other attributes that may be included in the HOK assertion may be, for example, the user name of the authenticated user, the time and method of authentication, and the validity of the assertion. Unlike bearer assertions which can be used by any end entity presenting the assertion, by including the public key of the HOK key pair in the HOK assertion, end entity 102 is cryptographically bound to the HOK assertion issued by identity server 108. When the end entity sends the HOK assertion to a resource server, the resource server verifies proof-of-possession of the HOK private key at the end-entity that sent the HOK assertion, in addition to other validation checks that the resource server typically performs on receiving an identity assertion.

Subsequent to receiving the HOK assertion, during certificate enrollment, end entity 102 may generate a certificate key pair and a Certificate Signing Request (CSR). The certificate key pair is typically different from the HOK key pair. The CSR is a request sent to PKI component(s) for a certificate and the CSR includes, among other information, the public key of the certificate key pair. Prior to sending the CSR to the PKI component(s), end entity 102 uses the private key of the HOK key pair to sign the CSR. End entity 102 may thereafter send the signed CSR to a PKI component (for example, cloud-hosted RA 104a) along with the HOK assertion.

Each RA 104 is a PKI component that is configured to perform certificate enrollment request vetting functions on behalf of at least one issuing CA 106. A PKI customer may, for example, use cloud-hosted RA 104a to set up customer accounts and certificate policies to be enforced in vetting CSRs. A customer account may include a set of certificate templates that may be used for different parts of the customer organizations, different user roles in the customer organization, designated administrators, and certificate policies associated with the customer. A certificate policy is a document that details the vetting policies and applicability of certificates issued under the certificate policy and other information, for example, as specified in RFC 3647. For instance, the PKI customer may use user interfaces driven by certificate templates provided by RA 104a to subscribe to PKI services and specify information and policies that are to be applied in vetting CSRs.

RA 104a may thereafter use the information and policies specified by the PKI customer to validate CSRs received from end entities. RA 104a may determine that the end entity associated with the identity assertion is authorized to request the CSR based at least one attribute included in the CSR. For example, RA 104a may determine that the named subject in the CSR match the named subject in the HOK assertion. In another example, when RA 104 determines that the named subject in the CSR does not match the named subject in the HOK assertion, RA 104a may determine in an authorization step that, for example, an administrator in a first department in an organization is authorized to send CSRs for requesting certificates for users in the first department. The authorization step may be used to, for example, check if attributes (such as role, agency and organization) in the identity assertion are valid for sending CSRs for requesting certificates for users within the organization and/or organization unit, as specified in the subject distinguished name of the CSR. Accordingly, in this example, RA 104a may determine that information identifying the first department is present in the HOK assertion and the CSR and RA 104 may use the HOK assertion to validate authenticity and integrity of the CSR.

Using the cloud-hosted PKI component therefore reduces the setup and management overhead for the PKI consumer to account-establishment and profile selection (for example, from a menu of standard profiles offered by the RA 104a). The certificate profile (also referred as profile herein) is synonymous with certificate template (also referred to as template herein) and refers to a process and information associated with issuing a certificate, for example, an authentication process, an authorization process, contents of the certificate (for example, default content), constraints on content values in the requested certificate type, and the formats of the certificate.

In specifying information and policies that are to be applied to CSRs, the PKI customer may assign CSRs either to a specified default profile or to a specialized profile. Subsequent to receiving the CSR and HOK assertion from end entity 102, RA 104a may select a certificate template corresponding to the CSR, wherein the policies associated with the selected certificate template may be used in determining which attributes are to be included in the issued certificate. For instance, RA 104a may select a certificate template by mapping the attributes in the CSR to one or more predefined certificate templates, based on subscription data (for example, template selection policies set up by the PKI customer or other information in the PKI customer account). For example, a customer account may define rules of the RA, such as rules suggesting new attributes in the CSR or rules indicating that a CA may add new attributes in the issued certificate based on attributes present in the identity assertion. In an example, one or more the certificate policies requested in the CSR may be used to determine the certificate template as well as attributes to be added to the issued certificate. In another example, an organization field, an organization unit field, and a location field in the subject's distinguished name field or subject's alternate name fields in the CSR may also be used to determine the certificate template as well as attributes to be added to the issued certificate.

RA 104a may use one or more policies associated with the selected template may be used in determining which attributes are to be included in the issued certificate. Non-limiting examples may include policies that indicate that RA 104a may only verify that there is a HOK assertion associated with the CSR before sending the CSR to an issuing CA 106, policies that indicate that RA 104a may determine that the HOK assertion associated with the CSR include certain attributes that are aligned with attributes in the CSR, and/or policies that indicate that RA 104a may forward the CSR to a specific RA user for the RA user to manually vet the CSR. Subsequent to receiving the CSR, the PKI components (in the cloud and/or outside of the cloud) validate authenticity and integrity of the CSR by, for example, verifying the signature of the HOK assertion, that the CSR is signed with a HOK private key associated with the HOK assertion issued by identity server 108, (for example, the identity server listed in a specific agency account); that a name space in the CSR is allowed for the account associated with the CSR; that the name in the CSR maps to an identity token in the HOK assertion per account rules; and/or that other attributes in the CSR are allowed based on the name and attributes included in the HOK assertion and rules established for the account.

In some embodiments, subsequent to receiving the CSR and HOK assertion, RA 104a may use the HOK assertion to vet the CSR and subsequent to vetting the CSR and the HOK assertion, RA 104a may forward the CSR and the HOK assertion to, for example, CA 106a for CA 106a to issue the certificate requested in the CSR. For instance, RA 104a may use the HOK assertion to validate authenticity and integrity of the CSR by, for example, validating that the signature on the HOK assertion belongs to identity server 108, validating the signature on a message including the CSR using the public key presented in the identity assertion and validating the subject in the CSR using the public key presented in the identity assertion. RA 104a may or may not sign the CSR prior to sending the CSR and the HOK assertion to the issuing CA. In cases where RA 104a signs the CSR, RA 104a appends its signature to the existing signed CSR and may not remove the HOK signature on the CSR. This preserves the HOK signature on the CSR until it reaches a PKI component in a secure environment so that the integrity of the CSR is protected end-to-end (i.e., between the end entity and the PKI component in the secure environment), thereby removing the possibility of a cloud component tampering with the CSR. RA 104 may use the HOK assertion to validate authenticity and integrity of the CSR. The issuing CA may also validate the CSR and the HOK assertion and may use the HOK assertion to validate authenticity and integrity of the CSR prior to issuing a certificate as requested in the CSR. It should be noted that by cryptographically binding the CSR to the end entity with the HOK assertion and sending both the CSR and HOK assertion to the issuing CA 106, the signature of the cloud-hosted PKI component (i.e., RA 104a) is no longer required or relied upon to secure the CSR. This allows a PKI provider to leverage the cloud infrastructure and platforms for a significant amount of the PKI functionality, without risking compromise to CA 106 keys.

In other embodiments, RA 104a may use the HOK assertion to vet the CSR and may forward the CSR and the HOK assertion to RA 104b for RA 104b to perform further PKI functions on the CSR using the HOK assertion. For instance, similar to RA 104a, RA 104b may validate the signatures on the CSR and the holder of key assertion and validate the subject in the CSR. RA 104b may then sign the CSR with its private key and forward the signed CSR to CA 106a. In one embodiment, CA 106a may only validate the signature of RA 104b before issuing the certificate. In another embodiment, CA may validate the signature of RA 104b; validate the signature on the HOK assertion; verify the signature on the CSR using the public key in the HOK assertion; and/or verify the CSR subject information with that in the HOK assertion before issuing the certificate. In another embodiment, the CA may ignore the RA signature and only validate the CSR and the HOK assertion prior to issuing a certificate as requested in the CSR.

In using polices set up by the PKI customer, the PKI components may also determine whether subsequent manual vetting is required on the CSR. If it is determined that subsequent manual vetting is required on the CSR, an RA operator of, for example, RA 104a may log into RA 104a to manually vet the CSR. The RA user may vet the CSR with, for example, a key stored outside of the cloud.

Consider an example where the OAuth protocol is used in generating and using the HOK assertion. End entity 102 may generate a HOK key pair that is to be used in requesting a HOK assertion. Subsequent to receiving the HOK assertion with the public key of the HOK key pair from identity server 108, end entity 102 may generate a CSR and may generate a certificate key pair, wherein the public key of the certificate key pair is included in the CSR and is to be included a certificate issued in response to the CSR. End entity 102 may use the private key of the HOK key pair to sign the CSR before sending the CSR and the HOK assertion to cloud-hosted RA 104a.

Using the OAuth protocol, the proof of possession of the HOK key pair may be verified at RA 104a by verifying that the same public key in the HOK assertion was previously used for setting up a mutually authenticated Transport Layer Security (TLS) session between the end entity 102 and RA 104a. Embodiments do not rely on proof-of-possession of the HOK key pair being performed only at the cloud front-end RA 104a. The PKI components hosted in the secure environment, example, RA104b or CA 106 may independently verify proof-of-possession of the HOK key pair by the end entity by verifying the signature on the CSR.

According to policies associated with the CSR, subsequent to vetting the user of the CSR using, for example, the HOK assertion, RA 104a may forward the CSR, signed with the private key of the HOK key pair by end entity 102, and the HOK assertion to a PKI component hosted outside of the cloud 120 (for example, another RA 104b or CA 106). RA 104a may forward the signed CSR and the HOK assertion to a PKI component in secure environment 110, without modifying the CSR. In some embodiments, RA 104a may or may not sign the CSR before transmitted the CSR and HOA assertion to the PKI component hosted outside of the cloud 120. The HOK assertion along with the signed CSR may be validated independently at those PKI components hosted outside of the cloud infrastructure (for example, RA 104b and CA 106), even though those PKI components may lack direct connection to end entity 102.

If the signed CSR and the HOK assertion is sent to another RA (for example, RA 104b) that RA may perform further vetting functions and forward the signed CSR and the HOK assertion to an issuing CA, for example, CA 106a. In an embodiment, CA 106a has a trust relationship with identity server 108. Accordingly, subsequent to receiving the signed CSR and the HOK assertion, CA 106a may validate the signature on the HOK assertion (i.e., CA validates the signature of identity server 108 on the HOK assertion); may validate the signature on the CSR using the public key in the HOK assertion; and may validate the CSR subject information (i.e., the certificate subject name included in the CSR) with that in the HOK assertion.

In validating the CSR, CA 106a may determine a certificate type/template to be used for a subject role in the HOK assertion. CA 106a may select a certificate template by mapping data in the CSR and/or HOK assertion to at least one predefined certificate template, based on template selection rules, wherein the selected certificate template may be used to determine which attributes are to be included in an issued certificate. In response to the validation, CA 106a may approve the CSR for certificate issuance. The certificate issued by CA 106a may include the public key of the certificate key pair generated by end entity 102. In issuing the certificate, CA 106a may map data in fields of HOK assertion to fields in the certificate, based on the customer account, subscription data and/or the selected certificate template.

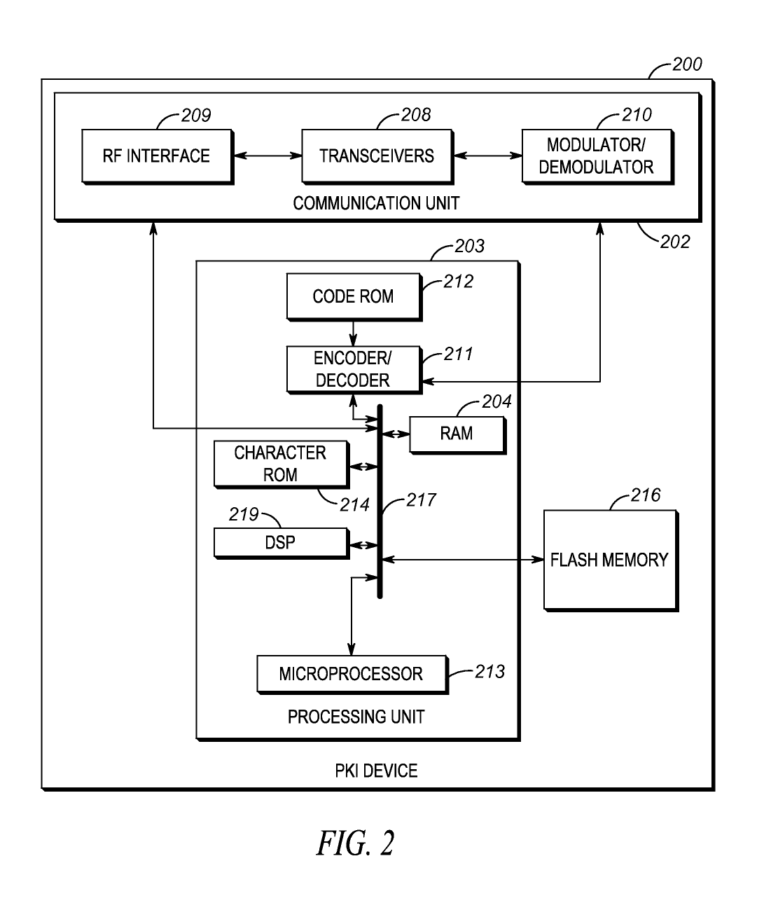

FIG. 2 is a block diagram of a PKI device 200, such as PKI devices 104 and 106, used in accordance with some embodiments. PKI device 200, for example, may include a communications unit 202 coupled to a common data and address bus 217 of a processor 203. The processor 203 may include, that is, implement, an encoder/decoder 211 with an associated code read-only memory (ROM) 212 for storing data for encoding and decoding voice, data, control, or other signals that may be transmitted or received by communication device 200. The processor 203 may further include one or more of a microprocessor 213 and digital signal processor (DSP) 219 coupled, by the common data and address bus 217, to the encoder/decoder 211 and to one or more memory devices, such as a character ROM 214, a random access memory (RAM) 204, and a flash memory 216. One or more of ROM 214, RAM 204 and flash memory 216 may be included as part of processor 203 or may be separate from, and coupled to, the processor 203. The encoder/decoder 211 may be implemented by microprocessor 213 or DSP 219, or may each be implemented by a separate component of the processor 203 and coupled to other components of the processor 203 via bus 217.

Communications unit 202 may include an RF interface 209 configurable to communicate with network components, and other user equipment within its communication range. Communications unit 202 may include one or more broadband and/or narrowband transceivers 208, perhaps operating in accordance with an IEEE 802.16 standard, and/or other similar type of wireless transceiver configurable to communicate via a wireless network for infrastructure communications. Communications unit 202 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 210 that is coupled to the encoder/decoder 211.

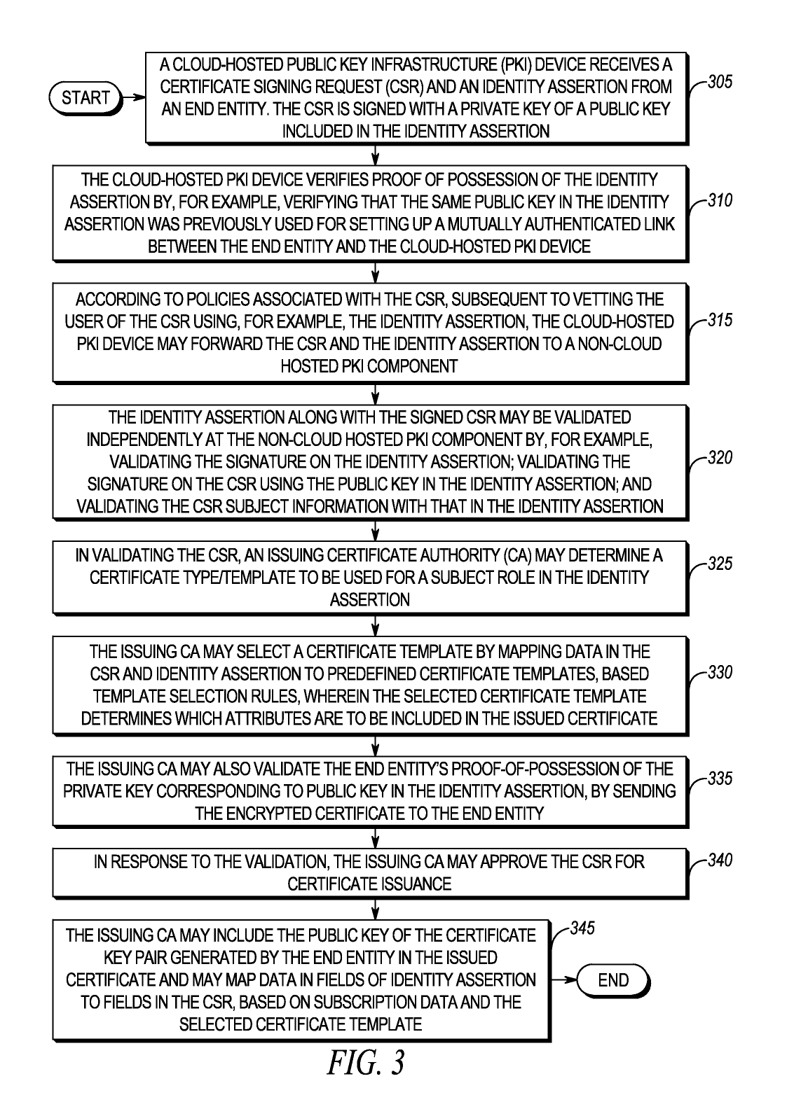

The one or more memory devices 212, 204, 216 store code for decoding or encoding data such as control, request, or instruction messages, channel change messages, and/or data or voice messages that may be transmitted or received by device 200 and other programs and instructions that, when executed by the processor 203, provide for the device 200 (for example, PKI devices 104 and 106) to perform the functions and operations described herein as being performed by such a device, such as the implementation of the encoder/decoder 211 and one or more of the steps set forth in FIG. 3.

FIG. 3 is a flow diagram of a method for processing a certificate signing request in a hybrid cloud PM environment in accordance with some embodiments. At 305, a cloud-hosted PKI device receives a CSR and an identity assertion from an end entity. The CSR is signed with a private key of a public key included in the identity assertion. At 310, the cloud-hosted PKI device verifies proof of possession of the identity assertion by, for example, verifying that the same public key in the identity assertion was previously used for setting up a mutually authenticated link between the end entity and the cloud-hosted PKI device. At 315, according to policies associated with the CSR, subsequent to vetting the user of the CSR using, for example, the identity assertion, the cloud-hosted PKI device may forward the CSR and the identity assertion to a non-cloud-hosted PKI component. At 320, the identity assertion along with the signed CSR may be validated independently at the non-cloud-hosted PKI component by, for example, validating the signature on the identity assertion; validating the signature on the CSR using the public key in the identity assertion; and validating the CSR subject information with that in the HOK assertion.

At 325, in validating the CSR, an issuing CA may determine a certificate type/template to be used for a subject role in the identity assertion. At 330, the issuing CA may select a certificate template by mapping data in the CSR and/or identity assertion to predefined certificate templates, based template selection rules, wherein the selected certificate template may be used to determine which attributes are to be included in the issued certificate. At 335, the issuing CA may also validate the end entity's proof-of-possession of the private key corresponding to public key in the identity assertion, by sending the encrypted certificate to the end entity. At 340, in response to the validation, the issuing CA may approve the CSR for certificate issuance. At 345, the issuing CA may include the public key of the certificate key pair generated by the end entity in the issued certificate and may map data in fields of identity assertion to fields in the CSR, based on subscription data and the selected certificate template.

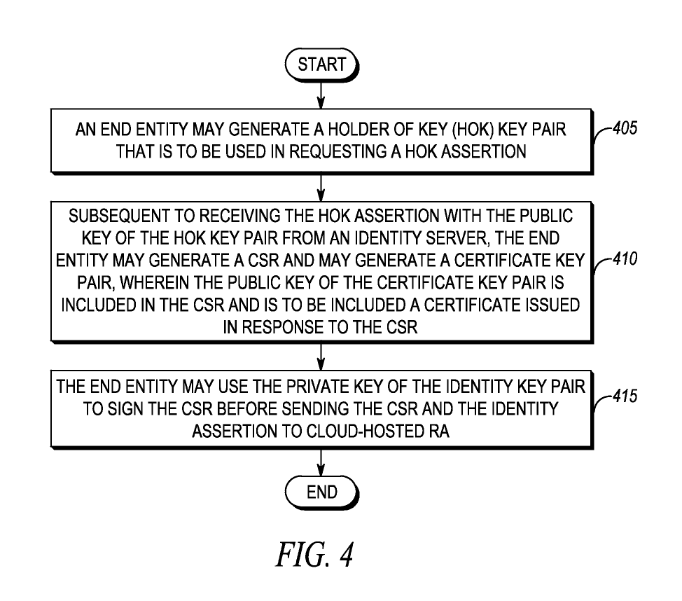

FIG. 4 is a flow diagram of a method for requesting a certificate in accordance with some embodiments. At 405, an end entity may generate a holder-of-key key pair that is to be used in requesting an identity assertion. At 410, subsequent to receiving the identity assertion with the public key of the holder-of-key key pair from an identity server, the end entity may generate a CSR and may generate a certificate key pair, wherein the public key of the certificate key pair is included in the CSR and is to be included a certificate issued in response to the CSR. At 415, the end entity may use the private key of the holder-of-key key pair to sign the CSR before sending the CSR and the identity assertion to cloud-hosted RA.

In an embodiment, the PKI cloud front-end (for example, RA 104a) may provide additional services to the end entity. For instance, the end entity may access a uniform resource locator (URL) of the PKI front-end that corresponds to an enterprise account and subsequent to entering a user name, the PKI front-end may prompt the end entity to enter other information that is to be included in the CSR that would aid the PKI components in the secure environment with vetting the CSR. Subsequent to receiving the requested information, the PKI front-end may send the additional information to the end entity, wherein the end entity may use the additional information to generate the CSR.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving, at a public key infrastructure (PKI) device, a certificate signing request (CSR) and an identity assertion cryptographically bound to an end entity issuing the CSR;
validating, by the PKI device, an authenticity and integrity of the CSR using the identity assertion; and
in response to validating the authenticity and integrity of the CSR, issuing, by the PKI device, a certificate based on at least one of the CSR and fields in the identity assertion.

2. The method of claim 1, wherein the PKI device is at least one of at least one first PKI device hosted on a cloud infrastructure and at least one second PKI device hosted in a secured environment.

3. The method of claim 1, wherein the validating comprises:
verifying a signature on the identity assertion;
verifying a signature on a message including the CSR using a public key presented in the identity assertion;
verifying a subject in the CSR using the public key presented in the identity assertion; and
approving the CSR for certificate issuance when the signature on the identity assertion, the signature on the message and the subject are validated.

4. The method of claim 1, wherein the issuing comprises:
selecting a certificate template by mapping data in the CSR to at least one predefined certificate template, based on template selection rules, wherein the selected certificate template determines which attributes are to be included in an issued certificate.

5. The method of claim 4, wherein the issuing comprises using the selected certificate template to identify rules for the PKI device to at least one of determine a new attribute in the CSR and add a new attribute to an issued certificate based on at least one attribute in the identity assertion.

6. The method of claim 1, wherein the validating comprises one of:
determining, by the PKI device, that a named subject in the CSR match the identity assertion; and
determining, by the PKI device, that the named subject in the CSR does not match the identity assertion and validating that the end entity associated with the identity assertion is authorized to send the CSR requesting the certificate using at least one attribute included in the CSR.

7. The method of claim 1, wherein the validating comprises:
verifying a signature on the identity assertion;
verifying a signature on a message including the CSR using a public key presented in the identity assertion;
verifying a subject in the CSR using the public key presented in the identity assertion; and
signing the CSR with a private key of the PKI device stored in a secured environment when the signature on the identity assertion, the signature on the message and the subject are validated.

8. The method of claim 7, wherein the validating comprises:
validating a signature of the CSR generated with the private key of the PKI device; and
approving the CSR for certificate issuance when the signature of the CSR is validated.

9. A public key infrastructure (PKI) device comprising:
a memory;
a transceiver configured to receive a certificate signing request (CSR) and an identity assertion cryptographically bound to an end entity issuing the CSR;
a processor configured to perform functions for:
validating an authenticity and integrity of the CSR using the identity assertion; and
in response to validating the authenticity and integrity of the CSR, issuing a certificate based on at least one of the CSR and fields in the identity assertion.

10. The PKI device of claim 9, wherein the PKI device is at least one of at least one first PKI device hosted on a cloud infrastructure and at least one second PKI device hosted in a secured environment.

11. The PKI device of claim 9, wherein the validating comprises:
verifying a signature on the identity assertion;
verifying a signature on a message including the CSR using a public key presented in the identity assertion;
verifying a subject in the CSR using the public key presented in the identity assertion; and
approving the CSR for certificate issuance when the signature on the identity assertion, the signature on the message and the subject are validated.

12. The PKI device of claim 9, wherein the issuing comprises:
selecting a certificate template by mapping data in the CSR to at least one predefined certificate template, based template selection rules, wherein the selected certificate template determines which attributes are to be included in an issued certificate.

13. The PKI device of claim 12, wherein the issuing comprise using the selected certificate template to identify rules for the PKI device to at least one of determine a new attribute in the CSR and add a new attribute to an issued certificate based on at least one attribute in the identity assertion.

14. The PKI device of claim 9, wherein the validating comprises one of:
determining that a named subject in the CSR match the identity assertion; and
determining that the named subject in the CSR does not match the identity assertion and validating that the end entity associated with the identity assertion is authorized to send the CSR for requesting the certificate using at least one attribute included in the CSR.

15. The PKI device of claim 9, wherein the validating comprises:
verifying a signature on the identity assertion;
verifying a signature on a message including the CSR using a public key presented in the identity assertion;
verifying a subject in the CSR using the public key presented in the identity assertion; and
signing the CSR with a private key of the PKI device stored in a secured environment when the signature on the identity assertion, the signature on the message and the subject are validated.

16. The PKI device of claim 15, wherein the validating comprises:
validating a signature of the CSR generated with the private key of the PKI device; and
approving the CSR for certificate issuance when the signature of the CSR is validated.

17. An apparatus comprising:
at least one cloud-hosted public key infrastructure (PKI) device and at least one non-cloud-hosted PKI device, each PKI device comprising:
a memory; and
a transceiver configured to receive a certificate signing request (CSR) and an identity assertion cryptographically bound to an end entity issuing the CSR;
wherein the at least one cloud-hosted PKI device further includes a processor configured to perform functions for at least one of:
validating an authenticity and integrity of the CSR using the identity assertion; and
determining that the end entity associated with the identity assertion is authorized to send the CSR using at least one attribute included in the CSR; and
wherein the at least one non-cloud-hosted PKI device further includes a processor configured to perform functions for at least one of:
validating the authenticity and integrity of the CSR using the identity assertion;
determining that the end entity associated with the identity assertion is authorized to send the CSR using at least one attribute included in the CSR; and
in response to validating the authenticity and integrity of the CSR, issuing a certificate based on at least one of the CSR and fields in the identity assertion.

18. The apparatus of claim 17, wherein the at least cloud-hosted PKI device is configured to receive the CSR and the identity assertion from a client device configured to generate a certificate key pair and the CSR, wherein the CSR includes a public key of the certificate key pair in the CSR.

19. The apparatus of claim 18, wherein the client device is configured to:
sign the CSR with a private key of a holder-of-key key pair generated by the client device; and
transmit, to a cloud-hosted PKI device, the CSR and the identity assertion, wherein the identity assertion includes a public key of the holder-of-key key pair.

20. The apparatus of claim 18, wherein in response to receiving the signed CSR and identity assertion, the at least cloud-hosted PKI device is configured to perform at least one of validating and determining functions and forward the signed CSR and identity assertion to the non-cloud-hosted PKI device,
wherein in response to receiving the signed CSR and identity assertion, the non-cloud-hosted PKI device is configured to perform at least one of the validating, determining and issuing functions.
